(19) United States
(12) Patent Application Publication
(10) Pub. No.: US 2014/0342030 A1
(43) Pub. Date: Nov. 20, 2014

(54) MOLD FOR IMPRINT AND METHOD FOR MANUFACTURING THE SAME

(71) Applicant: Sakae Nakatsuka, Shinjuku-ku (JP)

(72) Inventor: Sakae Nakatsuka, Shinjuku-ku (JP)

(73) Assignee: HOYA CORPORATION, Tokyo (JP)

(21) Appl. No.: 14/360,816

(22) PCT Filed: Sep. 13, 2012
(86) PCT No.: PCT/JP2012/073414

§ 371 Date: Jul. 29, 2014

(30) Foreign Application Priority Data
Nov. 25, 2011 (JP) 2011-257100

(51) Int. Cl. B29C 59/00

(52) U.S. Cl. CPC B29C 59/002; B29L 2031/34
USPC 425/385; 427/271

(57) ABSTRACT

Provided is a mold for imprint having a leveling agent layer in which a desired uneven pattern is formed on an outermost surface by embedding unevenness on a main surface of a base body by coting this portion with a leveling agent.

### TECHNICAL FIELD

The present invention relates to a mold for imprint and a method for manufacturing the same, and particularly relates to the mold for imprint with an uneven pattern formed thereon and the method for manufacturing the same.

### DESCRIPTION OF RELATED ART

Conventionally, in a field of a mechanical processing and a field of an electronic circuit, micron-order processing is carried out, and it is conventionally general to use a visible light when controlling such a processing, etc. However, there is a limit in the visible light in a point that only a micron-order control is enabled.

Meanwhile, an apparatus called a stepper is capable of performing processing of micron-order to nano-order (several 10 nm) by using a ultraviolet laser and a light having a shorter wavelength than a visible light from an extreme ultraviolet light source, or an electron beam.

Meanwhile, a considerable time is required for forming a pattern even in a case of the micron-order processing. Therefore, the time required for the nano-order fine processing is further increased. In addition when the ultraviolet laser and the extreme ultraviolet light source are used, a large-scale apparatus is required, thus increasing a cost. Further, a sequential processing is a technique of performing a fine processing by exposure and development using electron beams, thus reducing work efficiency.

Meanwhile, there is a photolithography method which is a technique of transferring a mask pattern which is formed on a glass plate, by exposure using a normal light. However, even if the photolithography is used, formation of a nano-order fine pattern depends on a resolution of a light, and therefore there is a limit in forming the nano-order fine pattern.

In order to cope with this problem, in recent years, attention is paid to a nano-imprint technique which is a method for transferring a fine pattern on a material to be transferred in an appearance of a stamp, using a mold having an uneven fine pattern thereon. The nano-imprint technique enables a fine structure of several 10 nm level to be fabricated with mass production at a low cost, with good reproducibility.

The imprint technique is largely divided into two kinds of heat imprint and optical imprint. The heat imprint is a method for pressing a mold having a fine pattern against a thermoplastic resin which is a material to be molded while heating the material to be molded, and thereafter cooling and releasing the material to be molded, to thereby transfer a fine pattern. Further, the optical imprint is a method for pressing a mold having a fine pattern against a light curing resin which is a material to be molded and irradiating it with UV-ray, and thereafter releasing the material to be molded, and transferring a fine pattern.

In either case of the above imprint methods, a further fine pattern is required to be transferred on a further larger material to be molded. Accordingly as a system used therefore, a batch transfer system of pressing a mold and a material to be molded at once, a step & repeat system of finally transferring a fine pattern on a substrate having a large area by repeatedly performing the abovementioned imprint method using a panel mold, and a roller system, etc., can be given (for example see patent documents 1 and 2). There is also a technique of plating a main surface of a cylindrical substrate with a metal layer using the roller system, and forming a fine pattern on the metal layer (for example, see patent document 3).

Incidentally, in order to transfer a fine pattern, there is a necessity for providing a fine pattern on the mold for imprint which is an archetype mold. The fine pattern is formed by using a technique such as a direct drawing on a layer for forming a fine pattern by irradiation of a blue laser or an electron beam (EB), etc., and an etching applied to the layer for forming a fine pattern after drawing/development of a fine pattern on a resist.

When the drawing of the fine pattern is performed, usually laser irradiation is performed after focusing on the main surface of the substrate. However, when there is an unevenness (scratched portion and non-scratched portion) on the main surface of the substrate (namely, in a case of a low flatness of the main surface of the substrate), the main surface of the substrate which is not flat is focused and this portion is irradiated with a laser beam. In this case, there is a problem of reducing a shape reproducibility of the fine pattern during drawing of the fine pattern. In order to solve such a problem, an applicant of the present application discloses a technique of providing a flattened layer on a substrate and providing a fine pattern thereon (see patent document 4).

### PRIOR ART DOCUMENT

### Patent Document

Patent document 1: Japanese Patent Laid Open Publication No. 2005-5284
Patent document 2: Japanese Patent Laid Open Publication No. 2008-73902
Patent document 3: Japanese Patent Laid Open Publication No. 2004-306554
Patent document 4: WO2011/093357

### SUMMARY OF THE INVENTION

### Problem to be Solved by the Invention

Patent document 4 gives an example of forming a fine pattern made of amorphous carbon on a flattened layer. However, in this case, there is a problem that an amorphous carbon film which forms a projection of the fine pattern is peeled from the flattened layer, when etching is applied thereto for forming the fine pattern.

However, in a case of patent document 4, even if the amorphous carbon film is peeled off from the flattened layer, it is also acceptable that the remaining amorphous carbon film is peeled off and a new amorphous carbon film is formed again, and patterning is performed thereto. Namely, in the case of patent document 4, etching is relatively easy because the amorphous carbon film is used as a base of the fine pattern, and further the fine pattern can be easily reproduced by the abovementioned technique.

However, transfer of the fine pattern is forced to be interrupted, if the abovementioned regeneration processing is performed every time the fine pattern is peeled off from the flattened layer. As a result, there is a problem that an advantage of a nano-imprint technique such that “a fine structure is fabricated with mass production at a low cost” is damaged.

Meanwhile, as described in patent document 3, in the technique of directly plating the main surface of the cylindrical substrate with copper, plating of copper is difficult depending on the kind of the cylindrical substrate. Further, when there is a deep scratch on the main surface of the cylindrical substrate although its width is small, a scratched portion becomes a hollow portion after plating, thus involving a problem that copper is easily peeled off from the main surface of the cylindrical substrate. Also, in a case of a large scratch, copper is deposited along a shape of this scratch, thus involving a problem that the shape of the fine pattern is influenced by the shape of the scratch unless a copper film having a considerable thickness is formed, even if the fine pattern is formed on the copper film.

An object of the present invention is to provide a mold for imprint having an uneven pattern with high precision, with no risk of peeling-off from a base body, and a method for manufacturing the same.

### Means for Solving the Problem

In order to achieve the abovementioned object, inventors of the present invention reexamine their own developed technique (patent document 4). As described above, in patent document 4, the flattened layer is provided on the base body, and the pattern layer is provided thereon. Then, by peel-off of the pattern layer from the flattened layer, the abovementioned problem is caused.

As a result of the reexamination, it is found that the pattern layer is preferably not provided separately, to solve the problem of peel-off from the base body. Namely, it is found that if the pattern is formed on the flattened layer itself, the problem of peel-off itself is solved. More specifically, it is found that two functions can be exhibited on the flattened layer, such as:

(Function 1) An uneven portion such as a scratch on the main surface of the base body is embedded in a portion where the flattened layer is brought into contact with the base body, to set this portion in a flat state.
(Function 2) An uneven pattern to be transferred on a transfer body, is formed in a portion where the flattened layer is brought into contact with the base body (portion in contact with an atmosphere, namely an outermost surface).

The present invention is provided based on the abovementioned new knowledge of the inventors of the present invention.

According to a first aspect of the present invention, there is provided a mold for imprint, including a leveling agent layer with a desired uneven pattern formed on an outermost surface, by embedding unevenness on a main surface of a base body by coating this portion with a leveling agent.

According to a second aspect of the present invention, there is provided the mold for imprint of the first aspect, wherein the base body is a cylindrical substrate.

According to a third aspect of the present invention, there is provided the mold for imprint of the first or second aspect, wherein the leveling agent layer is made of polysilazane.

According to a fourth aspect of the present invention, there is provided a method for manufacturing a mold for imprint, including:

forming a leveling agent layer on a base body for leveling the base body by embedding an unevenness on a main surface of the base body by coating this portion with a leveling agent; and

forming a desired uneven pattern on the main surface of the leveling agent layer itself.

According to a fifth aspect of the present invention, there is provided the method for the fourth aspect, wherein the base body is a cylindrical substrate.

According to a sixth aspect of the present invention, there is provided the method for the fourth or fifth aspect, wherein the leveling agent layer is made of polysilazane.

### Effect of the Invention

According to the present invention, there are provided a mold for imprint having an uneven pattern with high precision without a problem of peel-off from a base body, and a method for manufacturing the same.

### BRIEF DESCRIPTION OF THE DRAWINGS

FIG. 1 is a sectional view schematically showing manufacturing steps of a mold for imprint according to an embodiment.

FIG. 2 is a schematic sectional expanded view showing a function of a leveling agent layer of the mold for imprint according to an embodiment.

FIG. 3 is a schematic view of the mold for imprint according to an embodiment, wherein (a) is a perspective view, (b) is a front view, and (c) is a sectional view taken along the line A-A′ of (b).

FIG. 4 is a schematic view showing a focusing when pattern drawing is performed, wherein (a) shows this embodiment, and (b) is a schematic view according to a conventional example.

FIG. 5(a) is an outer appearance photograph of a main surface of a substrate (not patterned) in a state that a mask layer and an inorganic resist layer are sequentially formed on a leveling agent layer in example 1, and FIG. 5(b) is an optical microscope photograph of the main surface of the substrate (not patterned) in a state that the mask layer and the inorganic resist layer are sequentially formed on the leveling agent layer.

FIG. 6(a) is an outer appearance photograph of a main surface of a substrate (not patterned) in a state that no one of the planarized layer, mask layer, and inorganic resist layer is formed in comparative example 1, and FIG. 6(b) is an optical microscope photograph of the main surface of the substrate (not patterned) in a state that no one of the planarized layer, mask layer, and inorganic resist layer is formed.

FIG. 7 is a photograph showing an observation result in planar view obtained by a scanning electron microscope, which is the observation result of the main surface of the mold according to an example, wherein (a) corresponds to example 1, (b) corresponds to example 2, (c) corresponds to example 3, (d) corresponds to example 4, and (e) corresponds to example 5.

FIG. 8 is a photograph showing an observation result in sectional view obtained by a scanning electron microscope, which is the observation result of the main surface of the mold according to an example, wherein (a) corresponds to example 1, (b) corresponds to example 2, (c) corresponds to example 3, (d) corresponds to example 4, and (e) corresponds to example 5.

### DETAILED DESCRIPTION OF THE INVENTION

Embodiments of the present invention will be described hereafter. In <Embodiment 1>, explanation is given in the following order.

1. A mold for imprint and a method for manufacturing the same
A) Preparation of a substrate
B) Coating of a leveling agent (leveling agent layer forming step)
C) Formation of an uneven pattern (uneven pattern forming step)
   a) Formation of a mask layer
   b) Formation of a resist layer
   c) Pattern exposure
   d) Development (formation of a resist pattern)
   e) Rinse treatment/drying
   f) Formation of a mask pattern
   g) Formation of an uneven pattern on a leveling agent layer
   h) Removal of a mask pattern and a resist pattern
   i) Cleaning, etc.
      2. Effect of the embodiment

In <Embodiment 1>, explanation is given for a case that a mask layer and a resist layer are sequentially provided on a leveling agent layer.

Also, in <Embodiment 2>, explanation is given for a case that the mask layer is not provided on the leveling agent layer.

Also, in <Embodiment 3>, explanation is given for a modified example other than the abovementioned embodiment.

Note that “flatness” in this embodiment means a surface roughness of a base body, and shows a level of a deviation of a surface where scratch, etc., is not supposed to exist, from a geometric plane. “Flatness (circularity or degree of flatness)” can be given as an index defined by JIS B 0182.

Further, in this embodiment, an uneven pattern is formed on a layer used originally as a flattened layer. Therefore, at least an outermost surface of the layer used originally as a flattened layer, is not flat. Therefore, in this embodiment, a layer having a leveling function on the main surface of the base body and having the uneven pattern on the main surface, is called a “leveling agent layer”.

Further, a factor of inhibiting the leveling of the main surface of the base body (for example a step generated on the main surface due to scratch or depression for example), is called an unevenness. This is different from a desired uneven pattern formed in future on the main surface of the leveling agent layer.

### Embodiment 1

### 1. Mold for Imprint and a Method for Manufacturing the Same

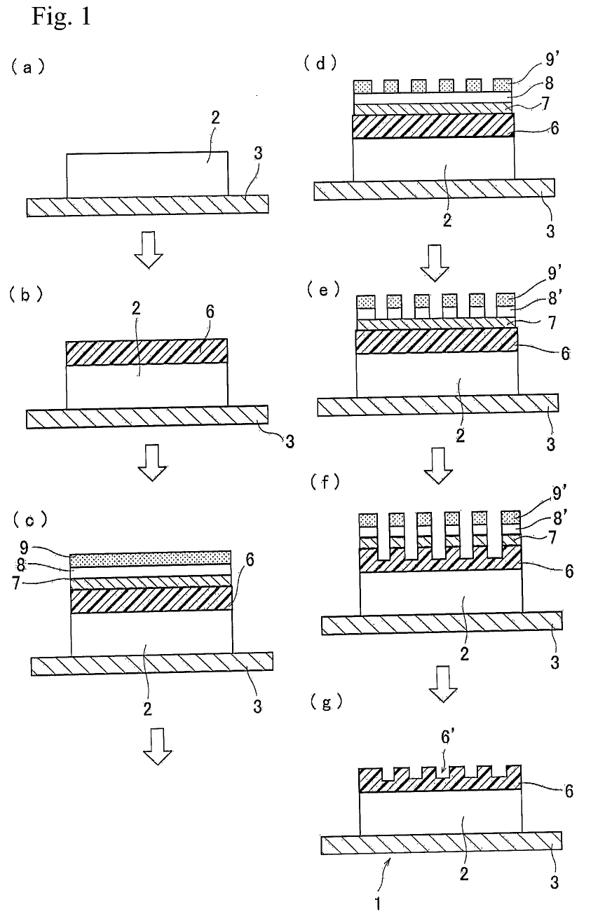

This embodiment will be described hereafter, using FIG. 1. FIG. 1 is a view schematically showing manufacturing steps of a mold for imprint 1 (simply called a mold 1 hereafter) according to this embodiment. FIG. 1(a) shows a base body which is a base of the mold 1 (a mold substrate 2 in this embodiment (simply called a substrate 2 hereafter)), and FIG. 1(b) shows a state that a leveling agent layer 6 made of a leveling agent is provided on the substrate 2. Further, FIG. 1 (c) shows a state that a mask layer 8 and a resist layer 9 are sequentially formed on the leveling agent layer 6, and FIG. 1(d) shows a state that a resist pattern 9′ is formed by drawing and developing a desired pattern on the resist layer 9. In addition, FIG. 1(e) shows a state that a mask pattern 8′ is formed by applying etching to the mask layer 8, and FIG. 1(f) shows a state that an uneven pattern 6′ is formed by applying etching to the leveling agent layer 6. Also, FIG. 1(g) is a view showing a state that cleaning is performed after etching, and the mask pattern 8′ and the resist pattern 9′ are removed, to thereby complete the mold 1.

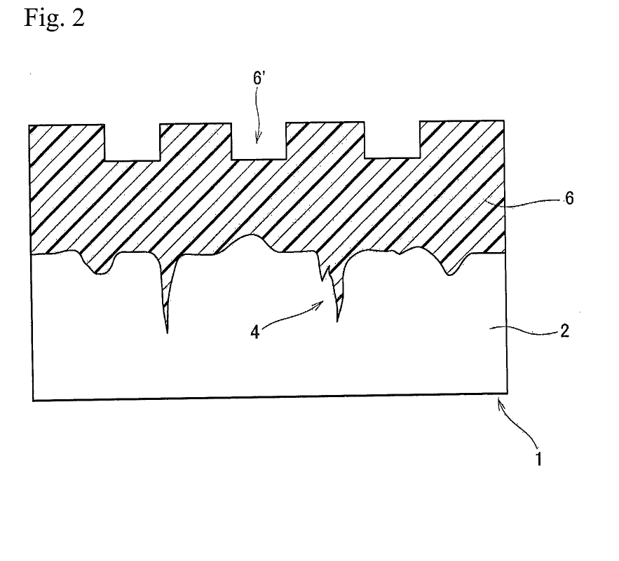

As shown in FIG. 2 which is a sectional schematic view of the mold 1 of this embodiment and an expanded view of FIG. 1(g), the mold 1 is obtained, wherein the leveling agent layer 6 is provided on the substrate 2, and a desired uneven pattern 6′ is provided on the main surface of the leveling agent layer 6 itself. In the mold 1 in this embodiment, although the leveling agent layer 6 is a single layer, unevenness (projection/depression) 4 such as a scratch that exists on the main surface of the substrate 2 is embedded to thereby change the substrate 2 in a flat state, in a portion where the leveling agent layer 6 is brought into contact with the substrate 2. Then, the uneven pattern 6′ is formed in a portion opposed to the portion where the leveling agent layer is brought into contact with the substrate 2 (portion in contact with an atmosphere, namely an outermost surface). When the uneven pattern 6′ is transferred on a transfer body using the mold 1 as an archetype mold, the outermost surface of the leveling agent layer 6 is a contact portion brought into contact with the transfer body.

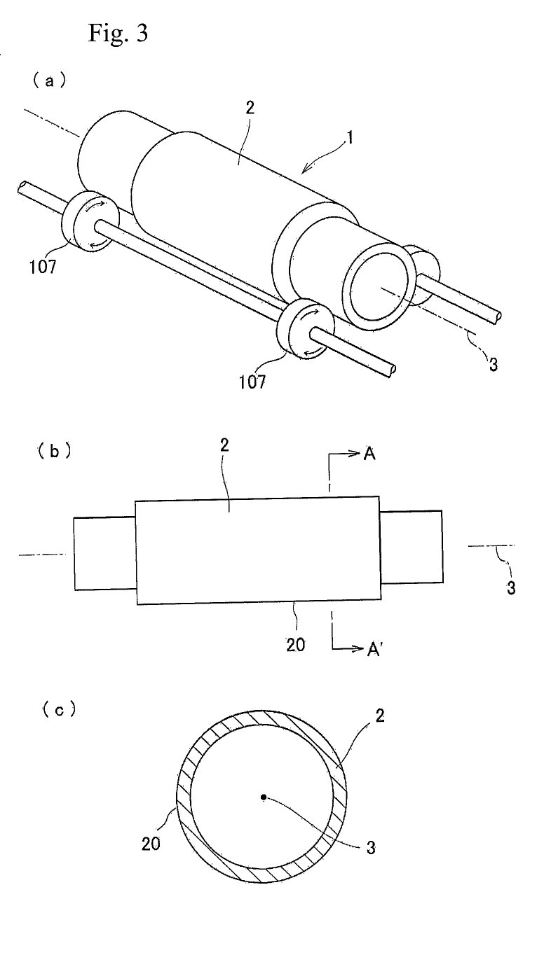

FIG. 3 is an overview diagram of the mold 1 when using it as an archetype mold. FIG. 3 is a schematic view of the mold 1 according to this embodiment, wherein (a) is a perspective view, (b) is a front view, and (c) is a sectional view taken along the line A-A′ of (b). The mold for imprint of this embodiment and the method for manufacturing the same will be more specifically described hereafter, based on FIG. 1 to FIG. 3.

a) Preparation of a Base Body

First, as shown in FIG. 1(a), the substrate 2 is prepared as the base body for the mold 1. Note that the “base body” in this embodiment includes the substrate as shown in this specification, and a base body having a hard mask on the substrate. Namely, the “base body” indicates the body including the substrate, and the body supposed to have the leveling agent layer 6.

The base body may be made of any composition if it can be used as the mold 1. A substrate made of alloy such as metal or stainless can be given in consideration of industrial durability. In addition, the base body such as a glass substrate like a quartz substrate, SiC substrate, silicon wafer substrate, and further a base body having a SiO₂ layer on the silicon wafer substrate, graphite substrate, and a carbon-based substrate such as a glassy carbon substrate and a carbon fiber reinforced plastic (CFRP), can be given.

Further, regarding a shape of the substrate 2, the shape is not limited, if the substrate 2 can be used as the mold 1. For example, a disc shape and a cylindrical shape can be given as the shape of the substrate 2. If the substrate 2 has the disc shape, the disc substrate 2 can be uniformly coated with the leveling agent, while being rotated. Further, if the substrate 2 has the cylindrical shape, imprint by a roller system is enabled, which is suitable for a mass production.

Note that the shape of the substrate 2 may be rectangular, polygonal, and semi-circular shapes, other than the disc shape. Further, polygonal shapes such as a column, triangular prism, and quadrangular prism, can be given as the shape of the substrate 2, other than the cylindrical shape. However, the column or the cylindrical shape is further preferable, because the uneven pattern can be continuously and uniformly transferred on the transfer material. In this embodiment, even if whichever shape is taken by the substrate 2, the base body used as the base of manufacturing a mold for imprint, is called a “substrate”.

This embodiment will be described hereafter using a cylindrical stainless steel substrate 2 with a hollow central portion. As shown in FIG. 3, the substrate 2 has right and left both side-end faces of the mold, a mold outer peripheral surface 20, and a rotation axis 3 which is not formed materially.

### B) Coating of a Leveling Agent (Leveling Agent Layer Forming Step)

As described above, there is a risk that a micron-order scratch exists on the substrate which is used for the mold 1 and reproducibility of the uneven pattern is considerably affected by this micron-order scratch.

Therefore, in this embodiment, the uneven pattern is not formed directly on the main surface of the substrate 2, or a layer having the uneven pattern is not separately provided, but a layer made of the leveling agent (called a leveling agent layer 6 hereafter) with the main surface of the substrate leveled by the leveling agent, is formed on the substrate 2. This is a different point from the conventional technique. The “leveling agent layer forming step” will be described in detail hereafter.

First, the leveling agent is selected. The “leveling agent” of this embodiment is the agent used for coating the main surface of the base body, and the agent capable of solving a leveling inhibition factor (unevenness) that exists on the main surface of the base body.

A conventionally used flattened film agent in liquid state can be given as a specific example of the leveling agent. However, specifically polysilazane, methylsiloxane, and metal alkoxide, etc., can be given. However, polysilazane is preferable, in consideration of easiness for forming the uneven pattern, and easiness for forming a new leveling agent layer 6 by removing the leveling agent layer when the uneven pattern 6′ of the leveling agent layer 6 is broken. However, substances other than the abovementioned substance such as a positive type resist composed of substituted naphthoquinonediazido and novolac resin, polystylene, polymethyl methacrylate, polyvinyl phenol, novolac resin, polyester, polyvinyl alcohol, polyethylene, polypropylene, polyimide, polybutadiene, polyvinyl acetate, and polyvinyl butylal, etc., may also be used. Further, if a good flatness can be maintained, the abovementioned substance alone or other substance mixed with the abovementioned substance may be used as the substance constituting the leveling agent layer 6.

The substrate 2 is held with the rotation axis 3 set in a horizontal state, and a vessel containing the leveling agent is prepared in a lower part of the substrate 2. Thereafter, the substrate 2 is descended downward, so that apart of the outer peripheral surface of the substrate 2 is brought into contact with the leveling agent. Then, a part of the substrate 2 is immersed in the leveling agent.

Here, the substrate 2 is preferably brought into contact with the leveling agent in parallel to a rotation axis direction. By such a parallel contact, difference in coating degree is not allowed to occur between the right and left both side-end faces of the mold. As a result, coating irregularity is not allowed to occur in the coating of the leveling agent.

Thus, the mold outer peripheral surface 20 is coated with the leveling agent by rotating the substrate 2 by a plurality of rollers 107 in a state that the leveling agent and the substrate 2 are brought into contact with each other in parallel to the direction of the rotation axis (FIG. 1(b)). Note that as shown in FIG. 3(a), a portion where the substrate 2 is rotated by a roller 107 may be separately provided on the substrate 2.

A rotation speed and the number of rotation at this time are set so that the substrate 2 can be sufficiently coated with the leveling agent.

The substrate 2 is coated with the leveling agent by performing the abovementioned technique. Thus, the main surface of the substrate 2 can be flat. Note that as shown in FIG. 2, such a flatness is obtained by coating the main surface of the base body with the leveling agent and embedding unevenness on the main surface of the base body to thereby level the substrate 2. “Embedding the unevenness” means a state that a depression is embedded at minimum, and also means a state that not only the scratch or the depression is embedded but also a projected portion is embedded, further a portion where the scratch or the depression does not exist originally is embedded with the leveling agent, and this state is preferable.

### C) Formation of the Uneven Pattern (Uneven Pattern Forming Step)

In this embodiment, the uneven pattern is formed on the leveling agent layer 6 itself made of the leveling agent which is used for coating as described above. In this embodiment, an example of forming the uneven pattern will be described.

### a) Formation of a Mask Layer

In order to form the uneven pattern, a mask layer 8 is laminated on the leveling agent layer 6. Thereafter, a resist layer 9 is laminated on the mask layer 8 (FIG. 1(c)).

Any kind of the mask layer 8 can be used if it has a function as a hard mask. The “hard mask” of this embodiment is composed of a single layer or multiple layers, and has a layered state used for etching applied to the substrate.

Any kind of substance constituting the mask layer 8 can be used if it is the substance capable of exhibiting the function as the hard mask. However, an opaque layer is preferable as the mask layer 8.

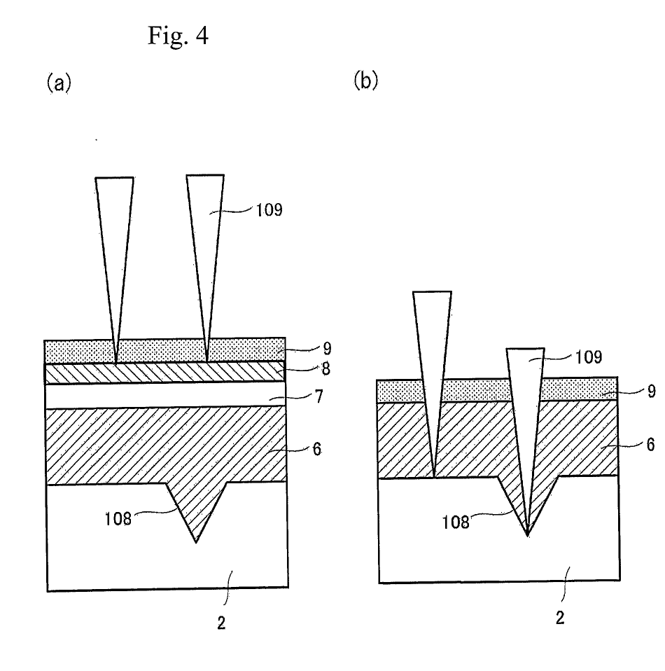

Further, transmittance of the mask layer 8 at a wavelength of 405 nm, is preferably in a suitable range. Then, as shown in FIG. 4(a), when the mask layer 8 is irradiated with a laser beam 109 from above the substrate 2 on which the mask layer 8 is laminated, the surface of the mask layer 8 can be surely focused by the laser beam 109 for pattern drawing. More specifically, a state as shown in FIG. 4(b) can be suppressed, namely, it is possible to suppress a state that a portion of a scratch 108 on a rough surface of the substrate is focused across the leveling agent layer 6 by the laser beam 109 used for drawing the uneven pattern.

The “opaque layer” in this embodiment means a layer which is opaque so that the surface of the mask layer is focused, when focusing for pattern drawing is performed from above the substrate 2 on which the mask layer 8 is laminated. Of course, the mask layer 8 itself may be the opaque layer, or the opaque layer may be separately provided on the substrate 2.

A chromium oxide layer (CrOx), a chromium nitride layer (CrNx), a chromium oxynitride layer (CrOxNy), a layer containing chromium and a compound thereof containing carbon (CrOxNyCz), a layer made of amorphous carbon, amorphous carbon nitride, or a combination of them, can be specifically given as an example of the mask layer 8.

Here, when the mask layer 8 includes a chromium oxide layer, a thickness of the chromium oxide layer is preferably set to be larger than 100 nm, and a thickness of the entire mask layer 8 is more preferably set to be larger than 100 nm and 1 μn or less. In a case of the thickness of 100 nm or more, the surface of the chromium oxide layer can be sufficiently focused. In a case of the thickness of 1 μm or more, practical use for pattern transfer can be realized.

Further, when the mask layer 8 includes the chromium nitride layer, a thickness of the chromium nitride layer is preferably 20 nm or more, and a thickness of the entire mask layer 8 is preferably 20 nm or more and 1 μm or less. Note that the thickness of the chromium nitride layer is more preferably 30 nm or more.

Further, when the mask layer 8 is composed of the chromium oxide layer and the chromium nitride layer, the thickness of the chromium nitride layer is preferably 20 nm or more, and the thickness of the entire mask layer 8 is preferably 20 nm or more and 1 μm or less.

Amorphous carbon may be used other than the chromium oxide layer and the chromium nitride layer. The amorphous carbon layer does not have a higher transparency than the chromium oxide layer, and therefore focusing on the substrate 2 can be prevented during drawing the uneven pattern. In a case of the amorphous carbon, the thickness of the amorphous carbon layer is preferably larger than 50 nm, and the thickness of the entire mask layer 8 is preferably large than 50 nm and 1 μm or less.

If the thickness of the layer made of each substance described here is in the abovementioned range, the mask layer 8 formed on the surface of the leveling agent layer 6, can be surely focused by the laser beam 109. Further, if the thickness of the entire mask layer 8 is in the abovementioned range, the mask layer 8 can be surely focused and an uneven pattern having a proper aspect ratio can be formed.

A publicly-known method such as a sputtering method may be used as a manufacturing method for the mask layer 8.

### b) Formation of a Resist Layer

Next, the main surface of the mask layer 8 is coated with resist. A spin coating method is used in this embodiment, which is the method for coating the main surface of the mask layer 8 with resist from above the substrate 2 while rotating the substrate 2 at a specific number of rotation. After coating the resist, baking treatment is applied thereto, to thereby form a resist layer 9 on the mask layer 8.

A publicly-known resist may be used as the kind of the resist, and chemically amplified resist may be used. Resist having reactivity when being irradiated with an energy beam may be used. Specifically, resist requiring development processing may be used. This embodiment shows a case that positive type resist is used, which is used for performing a pattern exposure by electron beam drawing. Note that when tungsten oxide (WOx) is used, laser drawing may be performed.

If the resist layer 9 is the positive type resist, solubility in a developing agent is improved at a portion where pattern exposure is performed by electron beam described later, thus forming a depression of a resist pattern 9′ composed of unevenness (projection and depression) formed after development processing, consequently corresponding to a position of the depression of the uneven pattern 6′ formed on the leveling agent layer 6. Meanwhile, if the resist layer 9 is a negative type resist, the pattern exposure part is hardened, and the solubility in the developing agent is reduced. As a result, a pattern having a corresponding relation opposite to projection/depression relation of the positive type resist, is formed.

Further, an adhesive layer 7 may be provided between the leveling agent layer 6 and the mask layer 8, and between the mask layer 8 and the resist layer 9, or on either one of them. Amorphous silicon is used for the adhesive layer 7. Of course, the adhesive layer 7 is not required to be provided if excellent adhesion is achieved when forming the leveling agent layer 6, the mask layer 8, and the resist layer 9.

### c) Pattern Exposure

A publicly-known pattern exposure such as electron beam drawing and lithography, etc., may be used as pattern exposure of this embodiment. Further, the shape of a pattern is not limited, and a line pattern, a dot pattern, or a mixture of them, etc., may be acceptable. As an example, a desired fine pattern for manufacturing bit patterned media (BPM) may be drawn on the resist layer using an electronic drawing device. Such a fine pattern may be micron-order, or may be nano-order from a viewpoint of a performance of a recent electronic device, and the nano-order is preferable in consideration of the performance of a final product fabricated by a patterned base body.

### d) Development (Formation of a Resist Pattern)

By developing the substrate 2 having the resist layer 9 on which drawings is performed, the resist pattern 9′ composed of a desired unevenness (projection and depression) is obtained as shown in FIG. 1(d). Note that a publicly-known method is also used for the development processing of this embodiment.

In this case, as described in b) formation of a resist layer, the resist layer 9 on which drawing is performed by blue laser, may be formed on the mask layer 8. A heat-sensitive material whose state is changed by heat change and suitable for the etching step thereafter, may be used as the resist layer 9 for drawing by blue laser. Further, a photosensitive material may also be used. In this case, an inorganic resist layer composed of tungsten oxide (WOx) having variation in its composition, is more preferable in a point of improving resolution.

### e) Rinse Treatment/Drying

Rinse treatment is applied to the substrate 2 having the resist pattern 9′ as needed, and thereafter bake treatment, etc., is applied thereto.

### f) Formation of a Mask Pattern

Thereafter, etching is applied to the mask layer 8 in a state that the resist pattern 9′ exists, to thereby form a mask pattern 8′ (FIG. 1(e)). A method for this etching may be determined according to a material of the mask layer 8, and dry etching or wet etching, etc., may be used according to the kind of the mask layer 8. For example, when amorphous carbon is used for the mask layer, dry etching using O₂ gas may be performed. Etching is also applied to the adhesive layer 7 as needed.

### g) Formation of an Uneven Pattern on the Leveling Agent Layer

Then, the leveling agent layer 6 is etched in a state that the mask pattern 8′ exists. As a result, a desired uneven pattern 6′ can be formed on the leveling agent layer 6 (FIG. 1(f)). Note that the etching method may be determined according to the kind of the leveling agent. For example, when polysilazane is used as the leveling agent, as an example, dry etching may be performed using Ar and CHF₃ gas. When etching is performed, buffered hydrogen fluoride can be used.

The desired uneven pattern (fine pattern) may be a pattern in a range of nano-order to micro-order, and further preferably has a periodic structure of several nm to several hundred nm. A fine projection structure including a plurality of fine projections/depressions can be given as a specific example. In a case of one-dimensional periodic structure, triangle, trapezoid, and rectangle, etc., can be given as a sectional shape of the fine projection. In a case of a secondary periodic structure, not only a precise cone (a generating line is a straight line) and pyramid (a ridge line is a straight line), but also a curved surface in which generating line and ridge line shapes are curved line, and a side face is bulged outward, may be acceptable if having a tapered shape in consideration of extraction after imprint. A hanging bell, cone, circular truncated cone, and column, etc., can be given as specific shapes.

Further, a tip end portion may be flattened or rounded in consideration of moldability and resistance to fracture. Also, the fine projections may be continuously fabricated in one direction.

### h) Removal of a Mask Pattern and a Resist Pattern

Thereafter, the remaining resist pattern 9′ is removed. Similarly, the remaining mask pattern 8′ is removed using a technique according to the material of the mask layer. Note that when the resist pattern 9′ is made of WOx as described in this embodiment, the resist pattern 9′ is removed when dry etching is applied to polysilazane. Also, similarly to the case of removing the mask pattern 8′ by dry etching, the mask pattern 8′ is removed using O₂ gas.

### i) Cleaning, Etc.

After end of the abovementioned step, cleaning, etc., is performed to the substrate 2 as needed. The leveling agent layer 6 is thus formed, having the uneven pattern on the main surface, to thereby complete the mold (FIG. 1(g)).

### 2. Effect of the Embodiment

As described above, the mold for imprint according to this embodiment is formed. According to this embodiment, the following effect can be exhibited.

Namely, the layer having a projection/depression uneven pattern is not provided separately on the flattened layer. Instead, the pattern is formed on the leveling agent layer itself, to thereby not allow the problem of peel-off of the uneven pattern to occur.

Then, instead of omitting the separately provided uneven pattern, the following two functions are provided to the leveling agent layer.

(Function 1) In a portion where the leveling agent layer is brought into contact with the base body, projection/depression such as scratches on the main surface of the base body is embedded to thereby change the base body to a flat state.
(Function 2) In the outermost surface of the leveling agent layer (surface opposed to the portion where the leveling agent layer is brought into contact with the base body), the uneven pattern is formed so as to be transferred on the transfer body.

Thus, there is no risk of the peel-off of the uneven pattern from the flattened layer, and therefore it is not necessary to perform a reproducing process of the uneven pattern which is performed every time the uneven pattern is peeled-off. Then, there is no necessity for interrupting the pattern transfer of the mold for imprint. As a result, a transfer work can be smoothly performed, and an advantage of the nano-imprint technique such that “a fine structure is fabricated with mass production” can be sufficiently utilized.

Further, as described in an initial object, projection/depression which is the leveling inhibition factor on the main surface of the base body, can be embedded with the leveling agent, so that an upper part of the main surface of the base body can be set in a flat state. Then, the projection/depression (scratched portion and non-scratched portion) on the main surface of the base body, is embedded with the leveling agent layer. Therefore, the flat portion can be easily focused when performing drawing by beams such as a blue laser and an electron beam (EB), etc. As a result, a desired uneven pattern can be formed without being influenced by the projection/depression of the base body.

From the above result, it is found that according to this embodiment, the mold for imprint having an uneven pattern with high precision having almost no risk of peel-off from the base body, and a method for manufacturing the same, can be provided.

### Embodiment 2

In embodiment 1, explanation is given for case that the mask layer 8 is provided. In embodiment 2, explanation is given for a case that the mask layer 8 is not provided, but the resist layer 9 is provided directly on the leveling agent layer 6 (or on the adhesive layer 7).

As described above, the mask layer 8 of embodiment 1 has a role of transferring the resist pattern 9′ on the leveling agent layer 6, and also has a role of focusing as an opaque layer at the time of pattern drawing. Therefore, in this embodiment, a material having high opacity is used as the leveling agent. Thus, focusing on a rough surface of the substrate can be prevented in pattern drawing. Namely, since the leveling agent itself is opaque, the flattened surface of the leveling agent layer 6 can be surely focused in pattern drawing. For example, a die additive-added leveling agent can be given as the leveling agent having opacity.

### Embodiment 3

In embodiment 1, explanation is given for a case that the mold 1 is fabricated by forming the resist layer and using this resist layer 9, after forming the leveling agent layer 6 and the mask layer 8. In embodiment 3, the mask pattern 8′ may be obtained by drawing directly on the mask layer 8, when amorphous carbon is used for the mask layer 8.

Further, the uneven pattern may be formed directly on the leveling agent layer 6 by direct drawing using electron beams, etc., not through the mask layer 8 and the resist layer 9.

Further, in embodiment 1, explanation is given for a case that the entire main surface of the cylindrical substrate 2 is coated with the leveling agent, to thereby form the leveling agent layer 6. Meanwhile, not the entire surface of the substrate 2 but a part of the substrate 2 may be coated with the leveling agent, to thereby partially form the leveling agent layer 6 on the main surface of the substrate 2. In this case, a plurality of leveling agent layers 6 may be formed on the main surface of the substrate 2.

As described above, embodiments of the present invention are given. However, the abovementioned disclosure content shows exemplary embodiments of the present invention, and the scope of the present invention is not limited to the abovementioned exemplary embodiments. The embodiments of the present invention can be variously modified by a skilled person based on the disclosure content of this specification, irrespective of whether or not there is a clear description or suggestion in this specification.

### EXAMPLES

### Example 1

The present invention will be specifically described next, by showing an example.

A stainless cylindrical hollow substrate 2 (SUS304 having diameter of 100 nm, namely radius of 50 nm, wherein diameter of a hollow portion is 84 mm and inter-distance of the mold end faces is 300 mm) was prepared.

Next, the leveling agent was prepared. A solution obtained by dissolving 20% of polysilazane in dibutyl ether was used as the leveling agent. A leveling agent container containing the polysilazane solution was disposed in a lower part of the substrate 2.

Thereafter, the substrate 2 was brought into contact with the polysilazane solution. At this time, a part of the outer peripheral surface 20 was immersed in the leveling agent in a depth corresponding to a distance of 0.3 mm or less from a liquid face of the leveling agent.

In this state, the mold was rotated three times at a rotation speed of 32 rotations/minute around a separately provided rotation axis 3, to thereby coat the entire outer peripheral surface 20 of the mold with polysilazane. At this time, the surface of the cylindrical substrate 2 was coated with the polysilazane solution so that the leveling agent layer 6 had a thickness of 1.5 μm.

Thereafter, the cylindrical substrate 2 and the leveling agent were separated from each other, and the substrate was dried while being rotated.

Next, the mask layer 8 and the inorganic resist layer 9 were laminated on the coated leveling agent layer in this order. Note that in this embodiment, the adhesive layer 7 was not provided. An amorphous carbon film was formed in a thickness of 200 nm as the mask layer 8. A tungsten oxide (WOx) layer was formed in a thickness of 20 nm by sputtering as the inorganic resist layer 9. Variation in composition in a depth direction of the inorganic resist layer 9 was as follows: substrate side x=0.95, resist outermost surface side x=1.60. When forming the inorganic resist layer 9, a flow rate ratio Ar:O₂ was continuously varied using an ion beam sputtering method, to thereby provide a variation in an oxygen concentration in the inorganic resist layer 9. Further, Rutherford Back Scattering Spectroscopy (RBS) was used for analyzing the composition of the inorganic resist layer 9.

A pattern of line and space (line:space=1:1) having a period of 180 nm was drawn on the inorganic resist layer 9 using a blue laser drawing device (wavelength of 405 nm) at an output of 11.8 mW, which was then developed, to thereby obtain the resist pattern 9′. Thereafter, dry etching by O₂ gas was applied to the mask layer 8, to thereby obtain the mask pattern 8′. Then, dry etching by Ar and CHF₃ gas was applied to the leveling agent layer 6 made of polysilazane, to thereby obtain the uneven pattern 6′. Note that dry etching by O₂ gas was used for removing the mask pattern 8′. Thereafter, cleaning was performed, to thereby fabricate the mold 1. At this time, an etching depth of the uneven pattern 6′ was set to 150 nm.

### Examples 2 to 5

The mold 1 was fabricated in each example, in which period and drawing output of the pattern were varied when drawing by blue laser. Specifically, the period was set to 160 nm and the output was set to 11.6 mW in example 2, the period was set to 140 nm and the output was 11.4 mW in example 3, the period was set to 120 nm and the output was set to 11. 4 mW in example 4, and the period was set to 100 nm and the output was set to 11.3 mW in example 5.

### Comparative Example 1

In comparative example 1, the leveling agent layer was not provided on the substrate 2. Namely, the stainless cylindrical hollow substrate 2 (SUS304 having diameter of 100 nm, namely radius of 50 nm, wherein diameter of a hollow portion is 84 mm and inter-distance of the mold end face is 300 mm) was prepared similarly to example 1, and the mask layer 8 and the inorganic resist layer 9 were laminated thereon in this order. Similarly to example 1 excluding the above point, the mold 1 was fabricated.

<Result>

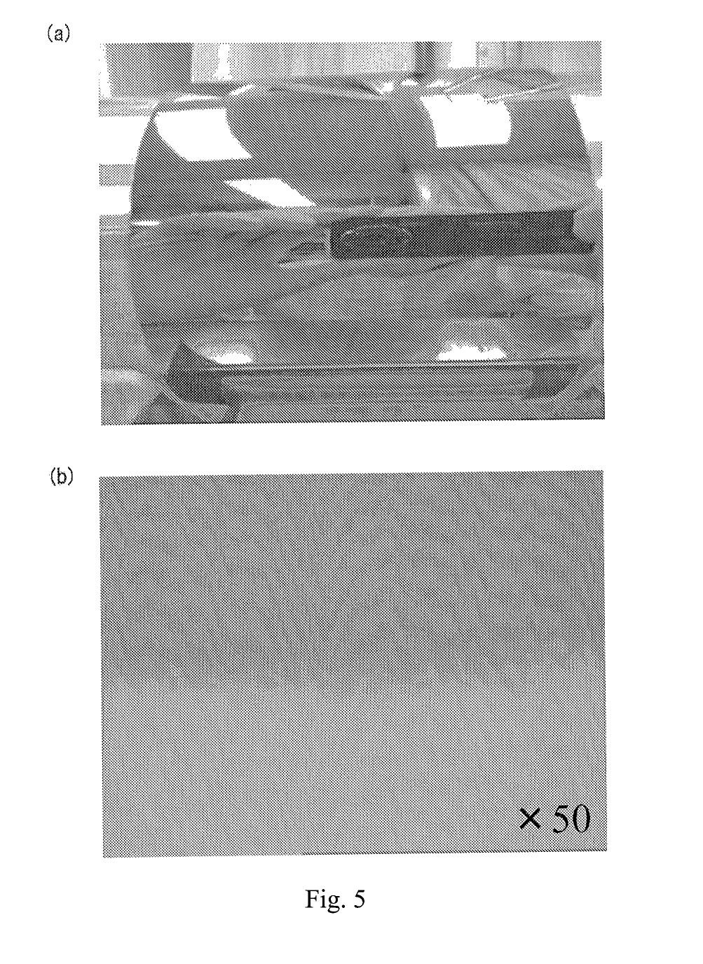

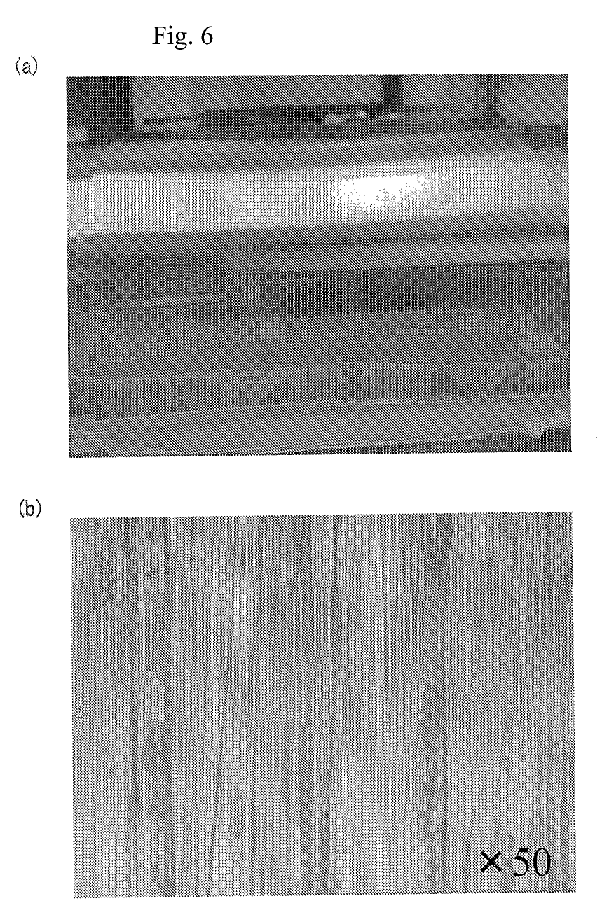

Example 1 and comparative example 1 are outer appearance photograph and an optical microscope photograph (50-fold magnifications) obtained by photographing the main surface of a non-patterned substrate (example 1 shows a state without the adhesive layer 7 as shown in FIG. 1 (c), namely the state that the mask layer 8 and the inorganic resist layer 9 are sequentially formed on the leveling agent layer 6, and meanwhile comparative example 1 shows a state that no one of the leveling agent layer 6, the mask layer 8, and the inorganic resist layer 9 is formed). The outer appearance photograph of the substrate after coating of the leveling agent, is shown in FIG. 5(a), and the optical microscope photograph is shown in FIG. 5(b). Also, the outer appearance photograph of the substrate of comparative example 1 is shown in FIG. 6(a), and the optical microscope photograph is shown in FIG. 6(b). When these results are compared, it is found that a sufficient flatness is realized by example 1, even in a level of a scale of the outer appearance photograph and the optical microscope photograph.

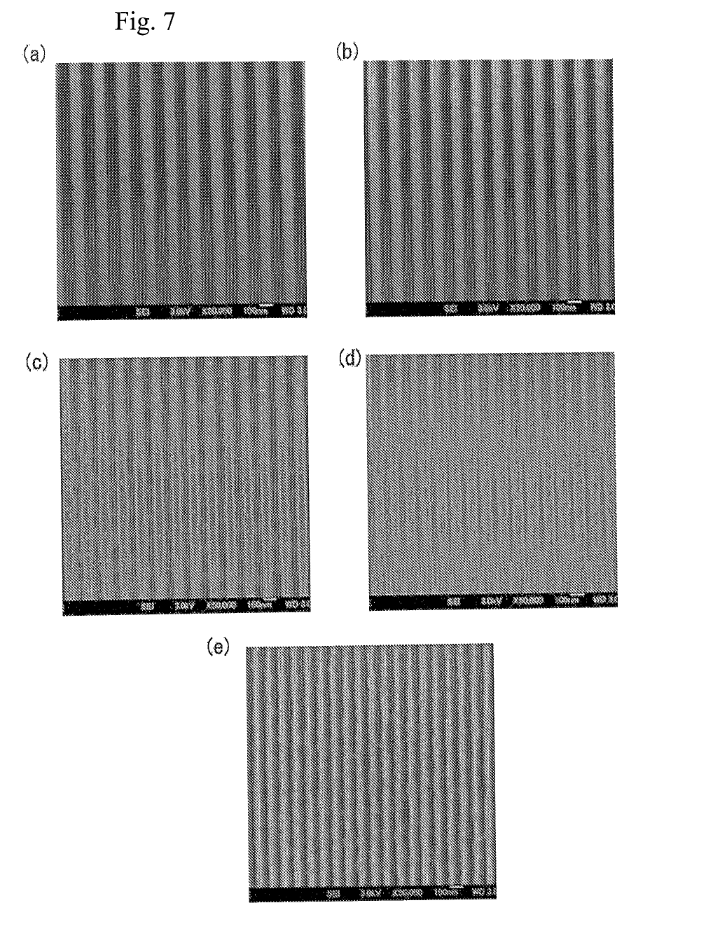

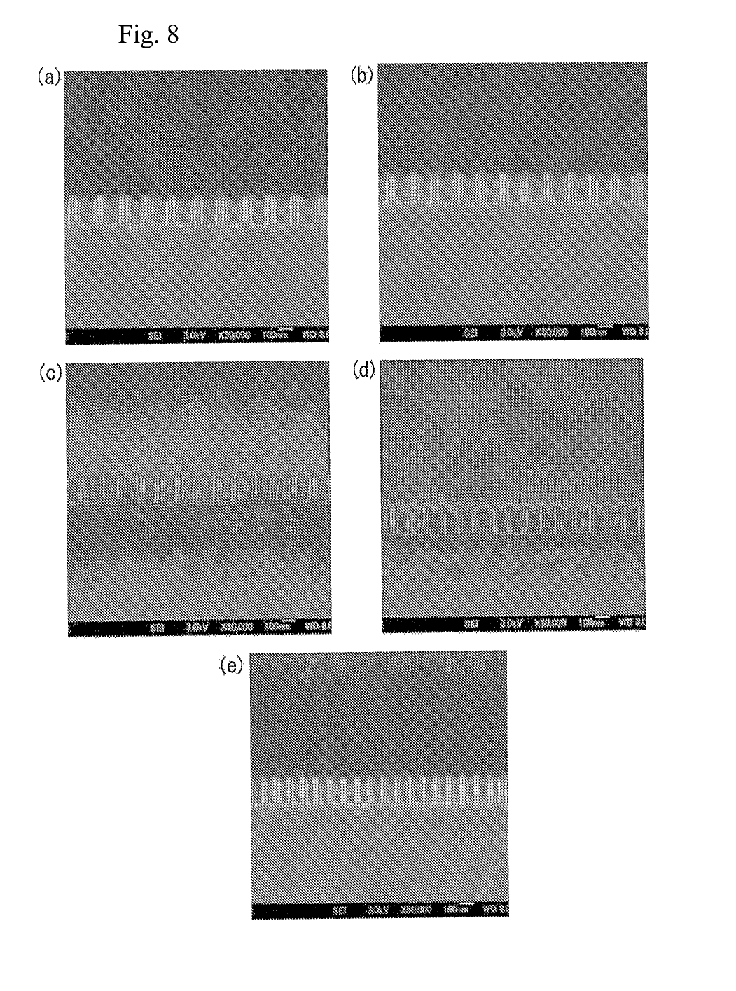

Further, in examples 1 to 5, an observation by the scanning electron microscope (50,000-fold magnifications) was performed. In examples 1 to 5, FIG. 7(a) to FIG. 7(e) show photographs in planar view, and FIG. 8 (a) to FIG. 8 (e) show photographs in sectional view. Note that CD (Critical Dimension) in a space portion of example 1 was 99 nm, and CD of example 2 was 86 nm, CD of example 3 was 66 nm, and CD of example 4 was 62 nm.

As a result, it is confirmed that in any one of the examples, the uneven pattern with high precision is formed on the main surface of the mold 1, and abnormality in focusing does not occur.

### DESCRIPTION OF SIGNS AND NUMERALS

1 Mold for imprint (mold)
2 Mold substrate (substrate)
20 Mold outer peripheral surface
3 Rotation axis
4 Unevenness (projection/depression)
6 Leveling agent layer
6′ Uneven pattern
7 Adhesive layer
8 Mask layer
8′ Mask pattern
9 Resist layer
9′ Resist pattern
107 Roller
108 Scratch on main surface of substrate
109 Laser beam

1. A mold for imprint, comprising a leveling agent layer with a desired uneven pattern formed on an outermost surface, by embedding unevenness on a main surface of a base body by coating this portion with a leveling agent.

2. The mold for imprint according to claim 1, wherein the base body is a cylindrical substrate.

3. The mold for imprint according to claim 1, wherein the leveling agent layer is made of polysilazane.

4. A method for manufacturing a mold for imprint, comprising:
forming a leveling agent layer on a base body for leveling the base body by embedding an unevenness on a main surface of the base body by coating this portion with a leveling agent; and
forming a desired uneven pattern on the main surface of the leveling agent layer itself.

5. The method for manufacturing a mold for imprint according to claim 4, wherein the base body is a cylindrical substrate.

6. The method for manufacturing a mold for imprint according to claim 4, wherein the leveling agent layer is made of polysilazane.

7. The mold for imprint according to claim 2, wherein the leveling agent layer is made of polysilazane.

8. The method for manufacturing a mold for imprint according to claim 5, wherein the leveling agent layer is made of polysilazane.
